(19) United States
(12) Patent Application Publication
(10) Pub. No.: US 2004/0164545 A1
(43) Pub. Date: Aug. 26, 2004

(54) Label/form combination

(75) Inventors: David L. Christianson, Viroqua, WI (US); Paul C. Blank, La Crosse, WI (US); Mary Ann Wehr, Hamilton, OH (US)

Correspondence Address: Douglas S. Foote, NCR Corporation, 1700 South Patterson Blvd., Dayton, OH, 45479-0001, US

(73) Assignee: NCR Corporation

(21) Appl. No.: 10/375,701

(22) Filed: Feb. 26, 2003

(51) Int. Cl. B42D 15/00

(52) U.S. Cl. 283/81

(57) ABSTRACT

A label/form combination for being printed in a laser printer. The combination includes a form sheet for printing information thereon, and a label adhesively bonded to the form sheet. The label includes a liner patch adhesively bonded to the form sheet, and a synthetic clear polyester sticker releasably bonded to the liner patch. The sticker has a thickness of about 1.5 mils or less, and the liner patch has a thickness of about 2.5 mils or less. The sticker also has a region coated with toner receptive ink or varnish for printing thereon by a laser printer. The thickness of the label including adhesives is about 5.5 mils or less.

### BACKGROUND OF THE INVENTION

The present invention relates generally to media products, and, more specifically, to business forms and labels.

A number of industries use customer information forms and reminder labels. For example, oil change businesses typically use an informational form and reminder label when servicing a motor vehicle for an oil change. The informational form provides details of the vehicle, service provided, cost, etc., and may be given to a customer as a record of service provided. The reminder label provides details such as the date and mileage of the service and next scheduled service. This label is adhered to the windshield, door jam, or similar surface on the vehicle as a convenient reminder to the customer.

Typically, the informational form and reminder label are separate consumables. The informational form, which is provided to the customer, has preprinted information fields which are filled in with vehicle, customer, and service specific information that are printed on the form during vehicle servicing. The form may be a continuous two ply dot matrix form or cut sheet single ply form.

The label comes from a separate roll of vinyl static cling or synthetic film sticker with a light tack releasable adhesive, which bonds the sticker to a backing liner. The label sticker is handwritten with service reminder information and the like, peeled from the liner, and applied to the inside of the windshield. A problem that arises with this application is that the handwriting can be illegible due to poor penmanship, smudging, or ultra violet (UV) fading of the ink. Moreover, it is easy to make mistakes in recording the service reminder information as well as mismatching the label and the printed informational form. It is also time-consuming and awkward to handle two different consumables.

An improvement to the two-part form and label, is a continuous, two-ply, self-contained, dot matrix form, with a reminder label releasably bonded to the front of the form. This form is produced by the assignee, NCR Corporation. The label is printed at the same time as the form thereby eliminating the problem of poor penmanship and reducing potential mismatching between the label and form. The label, two mil polypropylene, is mostly transparent with background printed information and a white region for providing enhanced contrast for service specific information, which is printed thereon by a dot matrix printer. The white region is printed on the label during its production using an ink which itself is receptive to oil-based inks, such as are used in dot-matrix printer ribbons.

However, the service specific information printed on the label is susceptible to UV fading, which is a characteristic of the standard inks used in ribbons for dot matrix printers. In addition, the printing can be faint at the outset due to not changing the printer ribbon in a timely manner. Because dot matrix printers typically have only a single paper feed, a second printer is normally required in order to print the work order. This increases costs and maintenance for the business. The polypropylene label is also too thick to work efficiently in a laser printer, and would also melt in the higher temperature environment of a laser printer.

### BRIEF SUMMARY OF THE INVENTION

The present invention is a label/form combination for being printed in a laser printer. The combination includes a form sheet for printing information thereon, and a label adhesively bonded to the form sheet. The label includes a liner patch adhesively bonded to the form sheet, and a synthetic sticker releasably bonded to the liner patch. The sticker includes a region coated with toner receptive ink or varnish for printing thereon by a laser printer.

In one embodiment, the synthetic sticker is a clear polyester having a thickness of about 1.5 mils or less, and the liner patch has a thickness of about 2.5 mils or less. The label includes adhesives bonding the liner patch to the form sheet, and the sticker to the liner patch, and the total thickness of the adhesives is about 1.3 mil or less.

### BRIEF DESCRIPTION OF THE DRAWINGS

FIG. 1 is top view of a label/form combination in accordance with an exemplary embodiment of the present invention.

FIG. 2 is a cross sectional view of the label/form combination taken along the cut 2-2 in FIG. 1.

FIG. 3 is a top view of the label/form combination of FIG. 1 after printing in a laser printer.

FIG. 4 is a view of the label/form combination of FIG. 3 with the sticker partially removed.

### DETAILED DESCRIPTION OF THE INVENTION

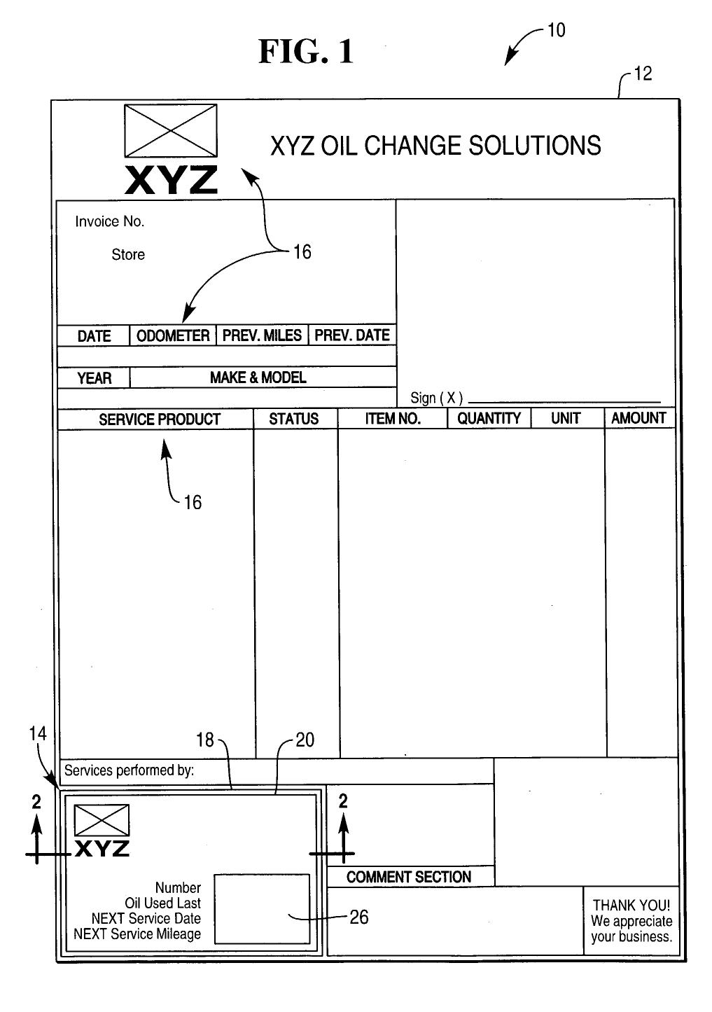

FIG. 1 shows a label/form combination 10 including a base form sheet 12 and label 14 adhesively bonded to sheet 12. Form sheet 12 has preprinted information designating a number of fields 16. For the business of servicing a motor vehicle, such fields may include the business name, odometer reading, service/product designation, etc.

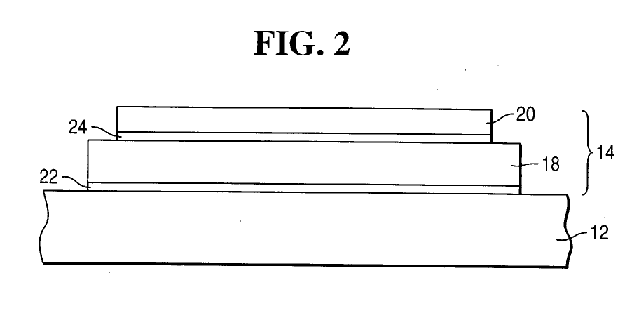

FIG. 2 shows a cross sectional view of label/form combination 10 taken along the cut 2-2 in FIG. 1. Label 14 includes a liner patch 18 and synthetic sticker 20. Liner patch 18 is adhesively bonded to form sheet 12 by an adhesive 22 which provides a secure bond therebetween. In a preferred embodiment, liner patch 18 is a semi-bleached kraft paper from 40# stock, with a thickness of about 2.5 mils or less. Adhesive 22 has a thickness of about 0.4 mils or less.

Sticker 20 is releasably bonded to liner patch 18 by an adhesive 24, which in a preferred form is a removable pressure sensitive acrylic adhesive. In a preferred embodiment, sticker 20 is a clear polyester, having a thickness of about 1.5 mils or less, and being able to withstand a desktop laser printer fuser temperature of 225° C. Adhesive 24 has a thickness of about 0.9 mils or less.

Referring again to FIG. 1, sticker 20 has a region 26 which is coated during a manufacturing operation with a toner receptive ink or varnish. The toner receptive ink or varnish can be clear or colored, and in a preferred embodiment, the ink or varnish is an opaque white laser imprintable ink which has good adhesion to flexible film labels.

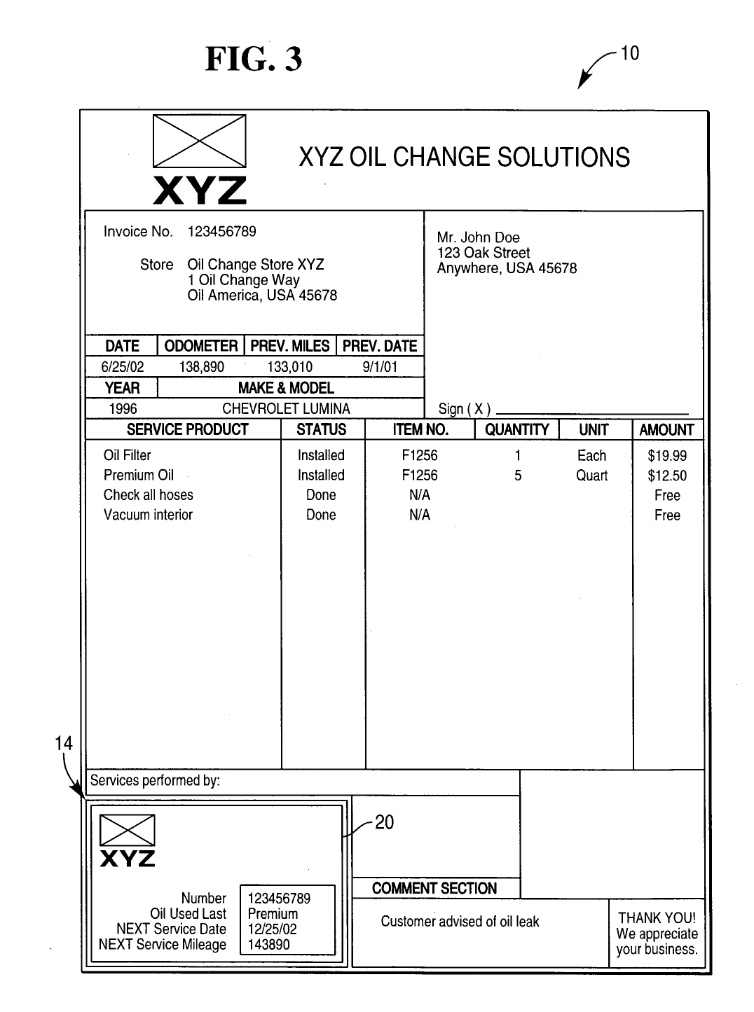

FIG. 3 is a view of the label/form combination 10 shown in FIG. 1 after printing in a laser printer. Label 14 has a thickness of about 5.3 mils in the disclosed embodiment, and preferably has a thickness of about 5.5 mils or less, which allows for some variations in the thicknesses described above. With a thickness of about 5.5 mils or less, a number of label/form combinations 10 can be stacked in a tray of a laser printer without excessive lean and without affecting their “pick-up” by feed rollers in the laser printer or jamming. Also, the polyester sticker 20 is capable of withstanding the pressure and temperatures of a laser printer.

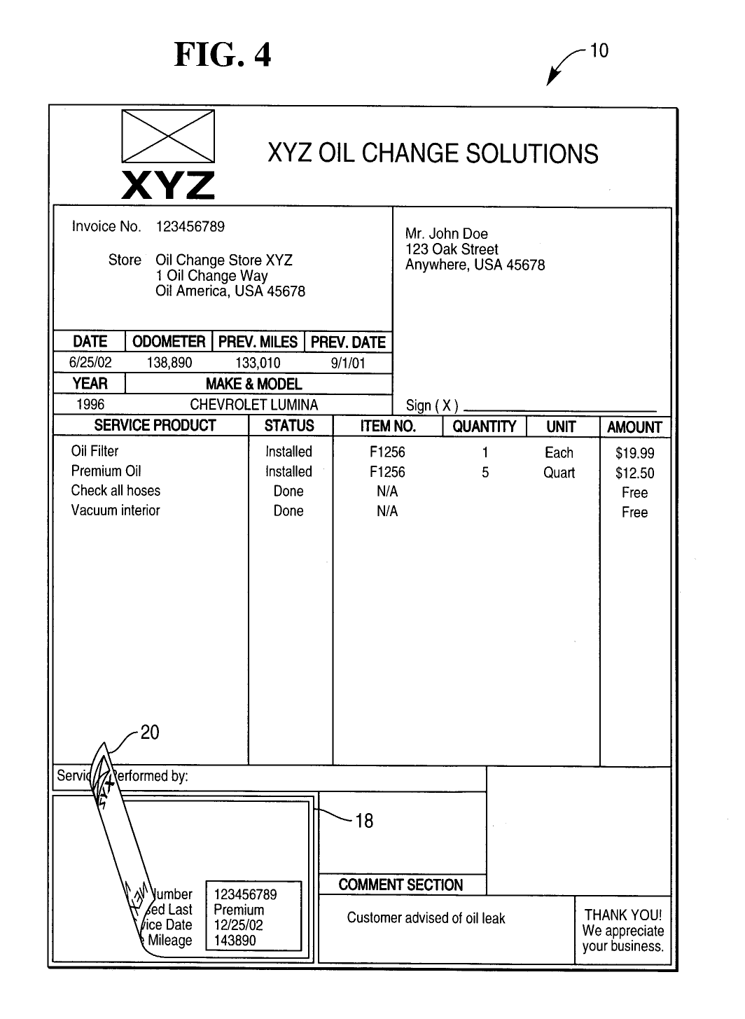

FIG. 4 is a view of the label/form combination 10 with a portion of sticker 20 peeled away from liner 18. The underside of sticker 20 will retain a coating of adhesive 24 (not shown) for adhering sticker 20 to a windshield or other service.

In servicing a motor vehicle, service and receipt information is entered into a computer, which is connected to a laser printer. Label/form combination 10 is positioned in a feed tray of the laser printer and automatically fed into the laser printer. The laser printer prints a receipt, such as shown in FIG. 3, and during the printing of the receipt also prints service information on removable sticker 20. Sticker 20 is then removed from liner 18 by peeling, as shown in FIG. 4, and attached to the vehicle being serviced, preferably on the inside of a windshield.

While there have been described herein what are considered to be preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

Accordingly, what is desired to be secured by Letters Patent of the United States is the invention as defined and differentiated in the following claims in which we claim:

What is claimed is:

1. A label/form combination for being printed in a laser printer, comprising:
a form sheet for printing information thereon; and
a label adhesively bonded to said form sheet, said label including
a liner patch adhesively bonded to said form sheet; and
a synthetic sticker releasably bonded to said liner patch;
wherein said sticker includes a region coated with toner receptive ink or varnish for printing thereon by a laser printer.

2. The label/form combination of claim 1, wherein said sticker has a thickness of about 1.5 mils or less.

3. The label/form combination of claim 1, wherein said synthetic sticker is polyester.

4. The label/form combination of claim 3, wherein said polyester is clear.

5. The label/form combination of claim 4, wherein said liner patch has a thickness of about 2.5 mils or less.

6. The label/form combination of claim 1, wherein said label includes adhesives bonding said liner patch to said form sheet, and said sticker to said liner patch; and wherein the thickness of said label is about 5.5 mils or less.

7. The label/form combination of claim 1, wherein said ink or varnish is white.

8. The label/form combination of claim 1, wherein:
said synthetic sticker is a clear polyester having a thickness of about 1.5 mils or less;
said liner patch has a thickness of about 2.5 mils or less; and
wherein said label includes adhesives bonding said liner patch to said form sheet, and said sticker to said liner patch; and wherein the total thickness of said adhesives is about 1.3 mil or less.

9. The label/form combination of claim 8, wherein said ink or varnish is white.

10. A label/form combination for use in servicing a motor vehicle, comprising:
a form sheet for laser printing service information thereon; and
a releasable sticker for laser printing service information thereon during the printing of said service information, and for attaching to said vehicle.

11. The label/form combination of claim 10, wherein said sticker is releasably adhered to a liner by a first adhesive, said liner is bonded to said form sheet by a second adhesive, and wherein the thickness of said sticker, liner, and adhesives is about 5.5 mils or less.

12. A method for use in servicing a motor vehicle of a customer, comprising:
laser printing a receipt for said customer on a form sheet;
laser printing service information on a removable sticker releasably bonded to said sheet during the printing of said receipt; and
removing said sticker from said sheet and attaching said sticker to said vehicle.
